(19) United States
(12) Patent Application Publication
(10) Pub. No.: US 2014/0056556 A1
(43) Pub. Date: Feb. 27, 2014

(54) OPTICAL SEMICONDUCTOR DEVICE

(71) Applicants: Yoshifumi Sasahata, Tokyo (JP); Tohru Takiguchi, Tokyo (JP); Keisuke Matsumoto, Tokyo (JP); Masakazu Takabayashi, Tokyo (JP)

(72) Inventors: Yoshifumi Sasahata, Tokyo (JP); Tohru Takiguchi, Tokyo (JP); Keisuke Matsumoto, Tokyo (JP); Masakazu Takabayashi, Tokyo (JP)

(73) Assignee: Mitsubishi Electric Corporation, Tokyo (JP)

(21) Appl. No.: 13/832,559

(22) Filed: Mar. 15, 2013

(30) Foreign Application Priority Data
Aug. 22, 2012 (JP) 2012-182906

(51) Int. Cl. F21V 8/00

(52) U.S. Cl. CPC G02B 6/0001
USPC 385/31

(57) ABSTRACT

An optical semiconductor device includes: semiconductor lasers separated into two groups; an optical coupler combining light output from the semiconductor lasers; an optical amplifier amplifying light output from the optical coupler; and waveguides respectively connecting the semiconductor lasers to the optical coupler. Each of the waveguides includes a respective bent waveguide. The bent waveguides have the same radius of curvature.

### BACKGROUND OF THE INVENTION

1. Field of the Invention

The present invention relates to an optical semiconductor device including the plurality of semiconductor lasers connected to the optical coupler by a plurality of bent waveguides, and in particular to an optical semiconductor device which can reduce variation in line width of output lights when the plurality of semiconductor lasers are respectively driven.

2. Background Art

In an optical semiconductor device in which output lights from a plurality of semiconductor lasers are combined by a multi-mode interference (MMI) coupler and amplified by a semiconductor optical amplifier (SOA), the plurality of semiconductor lasers are connected to the optical coupler by a plurality of bent waveguides (see, for example, Japanese Patent Laid-Open Nos. 2009-109704 and 2004-319893 and Japanese Patent No. 4444368).

### SUMMARY OF THE INVENTION

Variation in loss at the conventional semiconductor optical amplifier is large because the plurality of bent waveguides have different radii of curvature, so that the quantities of return light to the plurality of semiconductor lasers vary and the output lights from the plurality of semiconductor laser vary in line width.

In view of the above-described problems, an object of the present invention is to provide an optical semiconductor device which can reduce variation in line width of output lights when the plurality of semiconductor lasers are respectively driven.

According to the present invention, an optical semiconductor device includes: semiconductor lasers separated into two groups; an optical coupler combining output lights from the semiconductor lasers; an optical amplifier amplifying output light from the optical coupler; and a plurality of waveguides respectively connecting the semiconductor lasers to the optical coupler. The plurality of waveguides respectively includes bent waveguides. The bent waveguides have same radius of curvature.

The present invention makes it possible to reduce variation in line width of output lights when the plurality of semiconductor lasers are respectively driven.

Other and further objects, features and advantages of the invention will appear more fully from the following description.

### BRIEF DESCRIPTION OF THE DRAWINGS

FIG. 1 is a top view of an optical semiconductor device according to a first embodiment of the present invention.

FIG. 2 is an enlarged top view of a portion of the device shown in FIG. 1.

FIG. 3 is a top view showing the bent waveguide according to the first embodiment of the present invention.

FIG. 4 is a sectional view of the semiconductor laser taken along line I-II in FIG. 1.

FIG. 5 is a sectional view of the MMI coupler taken along line III-IV in FIG. 1.

FIG. 6 is a sectional view of the SOA 3 taken along line V-VI in FIG. 1.

FIGS. 7 to 10 are sectional views showing the process of manufacturing the optical semiconductor device according to the first embodiment.

FIG. 11 is a top view of an optical semiconductor device according to the comparative example.

FIG. 12 is an enlarged top view of a portion of the device shown in FIG. 11.

FIG. 13 is a top view of an optical semiconductor device according to a second embodiment of the present invention.

FIG. 14 is an enlarged top view of a portion of the device shown in FIG. 13.

FIG. 15 is a top view of an optical semiconductor device according to a third embodiment of the present invention.

FIG. 16 is an enlarged top view of a portion of the device shown in FIG. 15.

### DETAILED DESCRIPTION OF THE PREFERRED EMBODIMENTS

An optical semiconductor device according to the embodiments of the present invention will be described with reference to the drawings. The same components will be denoted by the same symbols, and the repeated description thereof may be omitted.

### First Embodiment

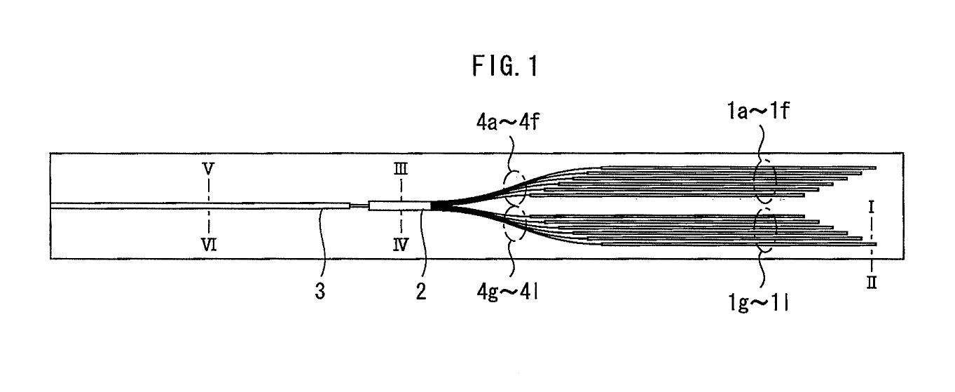

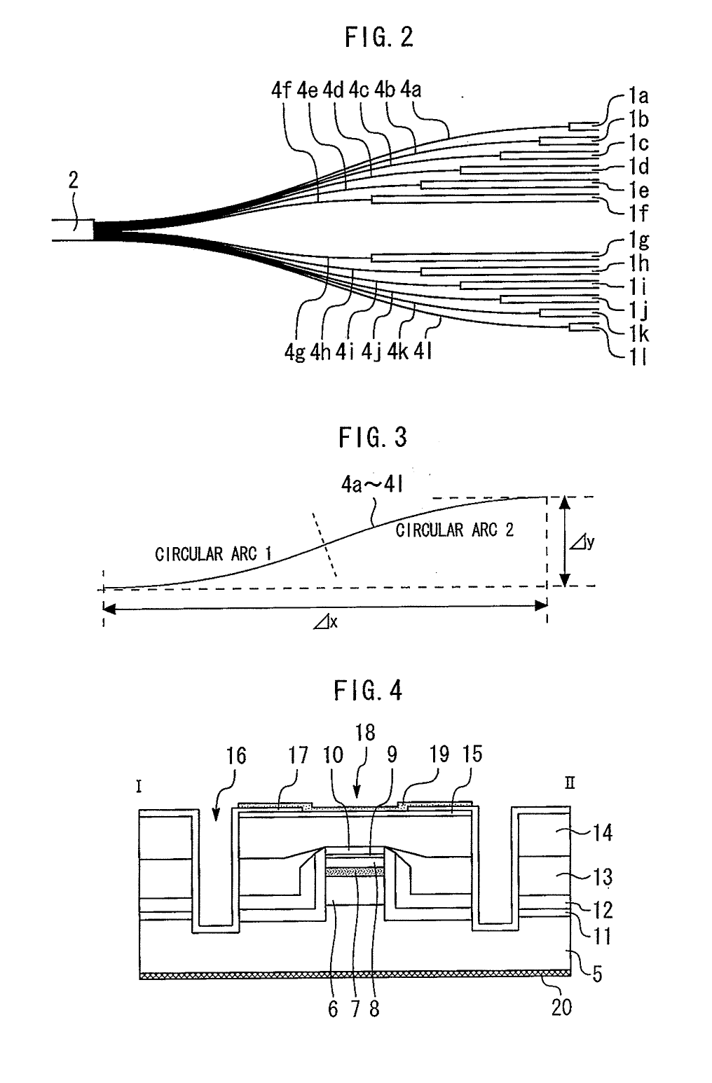

FIG. 1 is a top view of an optical semiconductor device according to a first embodiment of the present invention. FIG. 2 is an enlarged top view of a portion of the device shown in FIG. 1. A plurality of semiconductor lasers 1a to 1l are disposed by being separated into two groups. An MMI coupler 2 combines output lights from the plurality of semiconductor lasers 1a to 1l. A SOA 3 amplifies output light from the MMI coupler 2. A plurality of bent waveguides 4a to 4l respectively connect the plurality of semiconductor lasers 1a to 1l to the MMI coupler 2. The plurality of bent waveguides 4a to 4l have the same radius of curvature of 1000 μm.

FIG. 3 is a top view showing the bent waveguide according to the first embodiment of the present invention. Each of the plurality of bent waveguides 4a to 4l is formed of two circular arcs having the same radius of curvature of 1000 μm and different curvature centers.

FIG. 4 is a sectional view of the semiconductor laser taken along line I-II in FIG. 1. An n-type InP clad layer 6, an InGaAsP quantum well active layer 7, a p-type InP clad layer 8, a diffraction grating 9 and a p-type InP layer 10 are successively stacked on an n-type InP substrate 5. These layers form a ridge, two sides of which are buried by a p-type InP burying layer 11, an n-type InP blocking layer 12 and a p-type InP current blocking layer 13.

A p-type InP layer 14 and a p-type InGaAs contact layer 15 are successively stacked on the p-type InP layer 10 and the p-type InP current blocking layer 13. A mesa 16 is provided outside the ridge. The surface is covered with an insulating film 17 and an opening 18 is formed in the insulating film 17 at a position for electrode contact. A p-type electrode 19 is provided on the p-type InGaAs contact layer 15. An n-type electrode 20 is provided on a lower surface of the n-type InP substrate 5. The diffraction gratings 9 of the plurality of semiconductor lasers 1a to 1l differ in pitch from each other because of use as a wavelength variable laser.

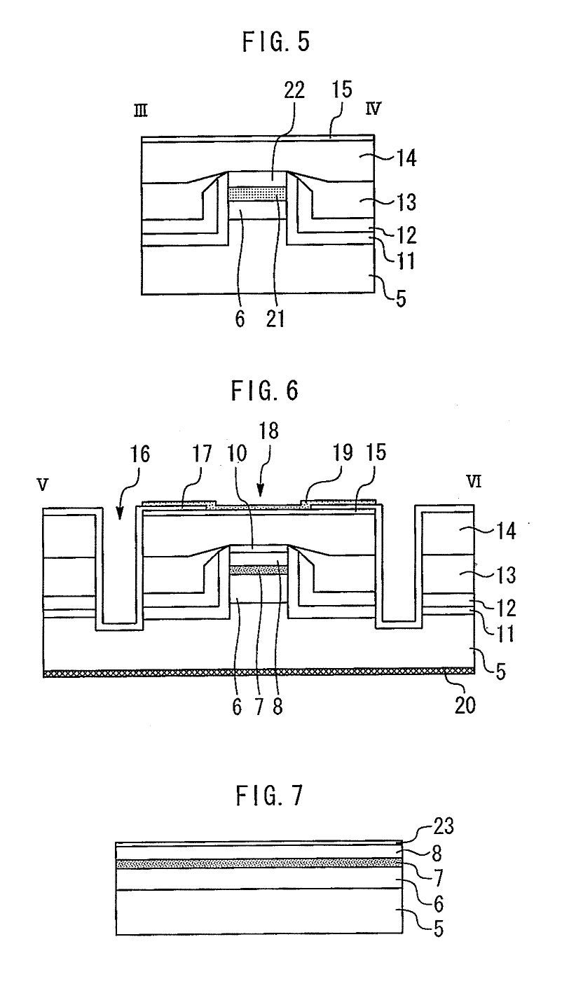

FIG. 5 is a sectional view of the MMI coupler taken along line III-IV in FIG. 1. An n-type InP clad layer 6, an InGaAsP waveguide layer 21 and an undoped InP layer 22 are successively stacked on the n-type InP substrate 5. These layers form a ridge. In other respects, the construction of the MMI coupler is the same as that of the semiconductor lasers. Also, each of the bent waveguides 4a to 4l is identical in structure to the MMI coupler 2 except that the ridge width is smaller. FIG. 6 is a sectional view of the SOA 3 taken along line V-VI in FIG. 1. The structure of the SOA 3 is the same as that of the semiconductor lasers except that the diffraction grating 9 is not provided.

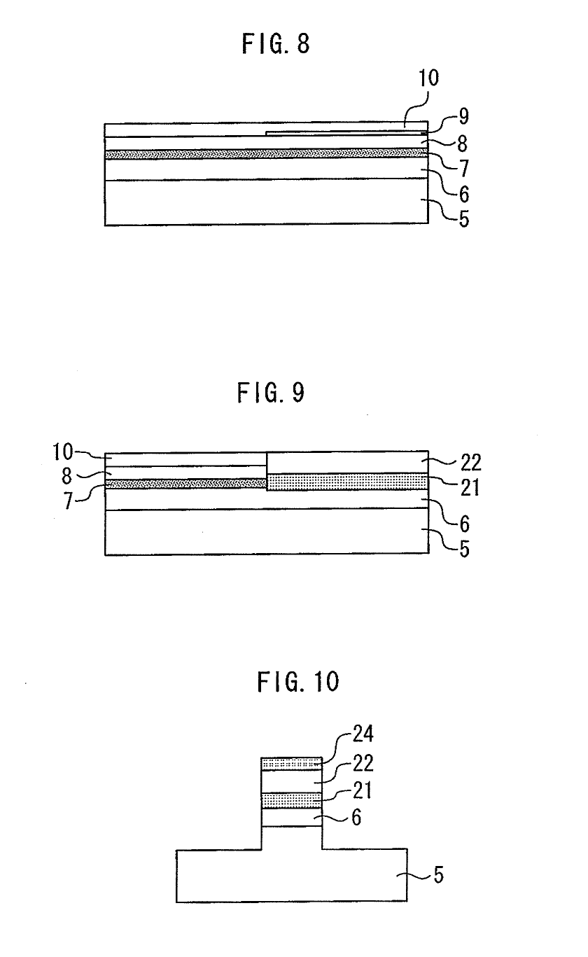

The process of manufacturing the optical semiconductor device according to the present invention will be described. FIGS. 7 to 10 are sectional views showing the process of manufacturing the optical semiconductor device according to the first embodiment. FIG. 8 corresponds to portions of the semiconductor lasers 1a to 1l and the bent waveguides 4a to 4l coupled to each other. FIG. 9 corresponds to portions of the MMI coupler 2 and the SOA 3 coupled to each other. FIG. 10 corresponds to a portion of the MMI coupler 2.

First, as shown in FIG. 7, the n-type InP clad layer 6, the InGaAsP quantum well active layer 7, the p-type InP clad layer 8 and a p-type InGaAsP diffraction grating layer 23 are grown in a crystal growth manner on the n-type InP substrate 5 by a metal organic chemical vapor deposition (MOCVD) method.

Next, as shown in FIG. 8, a diffraction grating pattern is formed of an insulating film at the positions at which the semiconductor lasers are to be formed, and the p-type InGaAs diffraction grating layer 23 is etched by using the insulating film as a mask to form the diffraction gratings 9. By this etching, portions of the p-type InGaAsP diffraction grating layer 23 other than those at the semiconductor laser formation positions are removed. After removal of the insulating film, the p-type InP layer 10 is grown.

Next, as shown in FIG. 9, the surface is covered with an insulating film at the positions at which the semiconductor lasers 1a to 1l and the SOA 3 are to be formed. Etching to the InGaAsP quantum well active layer 7 is then performed by dry etching or the like using the insulating film as a mask. Further, the n-type InP clad layer 6 is slightly removed. The InGaAsP waveguide layer 21 and the undoped InP layer 22 are then grown selectively. The insulating film is thereafter removed.

Next, as shown in FIG. 10, an insulating film 24 is patterned, and etching to an intermediate portion of the n-type InP substrate 5 is performed by using this insulating film 24 as a mask to form a ridge. The p-type InP burying layer 11, the n-type InP blocking layer 12 and the p-type InP current blocking layer 13 are then grown. After removal of the insulating film 24, the p-type InP layer 14 and the p-type InGaAs contact layer 15 are grown.

Next, an insulating film that covers surfaces portions other than those on the semiconductor lasers 1a to 1l and the SOA 3 is formed and the p-type InGaAs contact layer 15 is etched by using this insulating film as a mask. After removal of the insulating film, an insulating film is newly formed and patterned and the semiconductor lasers 1a to 1l and the SOA 3 are etched by using this insulating film as a mask to form the mesa 16. The insulating film is thereafter removed. Next, the insulating film 17 is formed, the opening 18 in the insulating film is formed at the portions for electrode contacts, and the p-type electrode 19 and the n-type electrode 20 are formed.

The operation of the optical semiconductor device according to the present embodiment will now be described. One semiconductor laser capable of obtaining the necessary oscillation wavelength is selected from the plurality of semiconductor lasers 1a to 1l and driven. Output light from this semiconductor laser is guided through the bent waveguide connected to this semiconductor laser and the MMI coupler 2 to enter the SOA 3. The SOA 3 amplifies this output light. However, the laser light is reflected at reflection points, e.g., the end surface, a butt joint and the MMI coupler. Return light from each reflection point passes through the bent waveguide and enters the semiconductor laser.

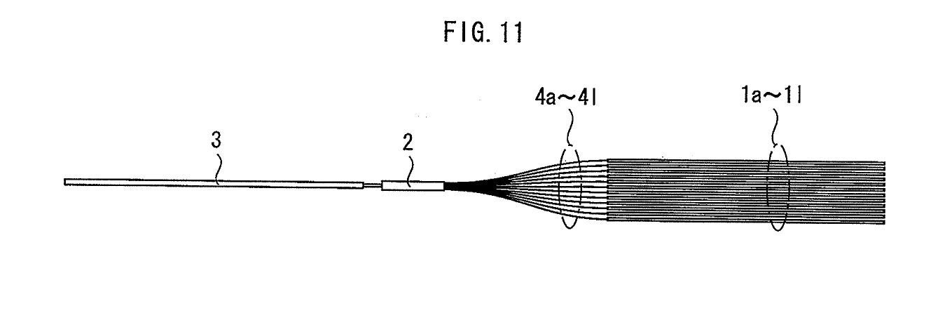

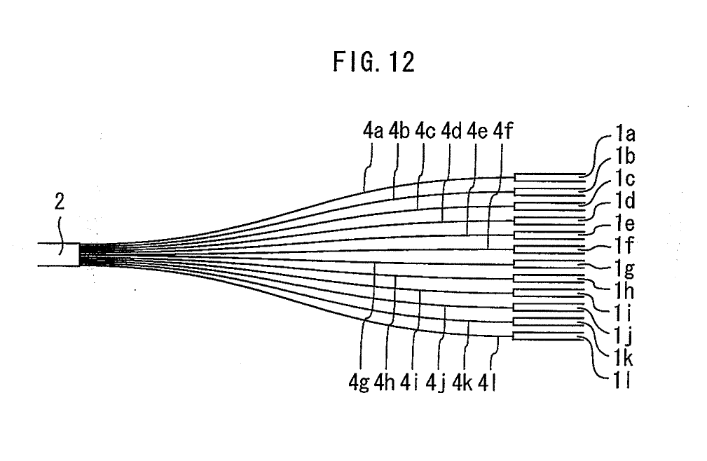

The effect of the present embodiment will be described in comparison with a comparative example. FIG. 11 is a top view of an optical semiconductor device according to the comparative example. FIG. 12 is an enlarged top view of a portion of the device shown in FIG. 11. In the comparative example, because a plurality of bent waveguides 4a to 4l have different radii of curvature, variation in loss is large. Therefore, the quantities of return light to the plurality of semiconductor lasers 1a to 1l vary and the output lights from the plurality of semiconductor laser 1a to 1l vary in line width.

In contrast, in the present embodiment, variation in loss is reduced since the radii of curvature of the plurality of bent waveguides 4a to 4l are equal to each other. Therefore, the differences between the quantities of return light to the plurality of semiconductor lasers 1a to 1l can be reduced to reduce variation in line width of output lights when the plurality of semiconductor lasers 1a and 1l are respectively driven.

Here, the loss is maximized in the outermost bent waveguides 4a and 4l, and is minimized in the innermost bent waveguides 4f and 4g. Variation in loss was calculated by setting Δx of the outermost bent waveguides 4a and 4l to 760 μm, setting Δy of these waveguides to 150 μm and setting the radii of curvature of these waveguides to 1000 μm. In the calculation results, while variation in loss in the comparative example was 3.3 dB, variation in loss in the present embodiment was 2.1 dB. Thus, variation in loss can be reduced by 1.2 dB in comparison with the comparative example.

### Second Embodiment

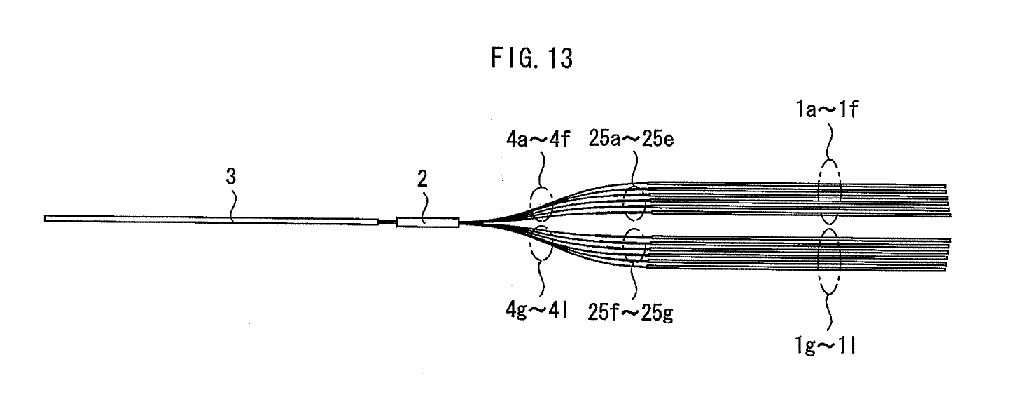

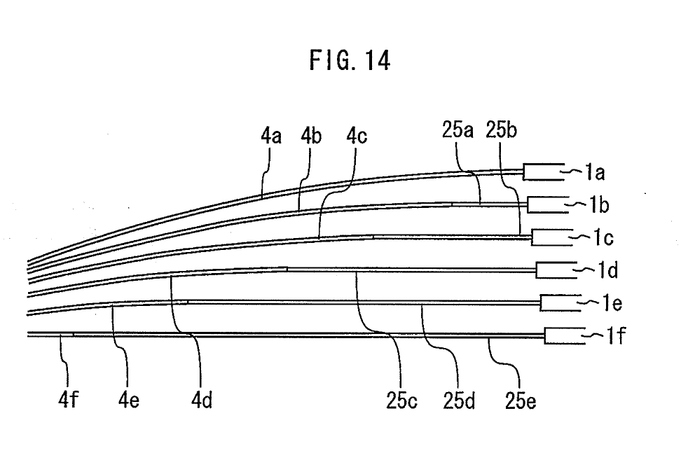

FIG. 13 is a top view of an optical semiconductor device according to a second embodiment of the present invention. FIG. 14 is an enlarged top view of a portion of the device shown in FIG. 13. Straight waveguides 25a to 25j are inserted between the plurality of bent waveguides 4b to 4k having the same radius of curvature and the plurality of semiconductor lasers 1b to 1k so that the lengths of the waveguides between the plurality of semiconductor lasers 1a to 1l and the MMI coupler 2 are equal to each other.

In this way, variation in loss can be further reduced in comparison with the first embodiment. Therefore, the differences between the quantities of return light to the plurality of semiconductor lasers 1a to 1l can be further reduced to further reduce variation in line width of output lights when the plurality of semiconductor lasers 1a and 1l are respectively driven.

Variation in loss was calculated by setting Δx of the outermost bent waveguides 4a and 4l in which the loss is maximized to 760 μm, setting Δy of these waveguides to 150 μm and setting the radii of curvature of these waveguides to 1000 μm. As a result of the calculation, variation in loss in the present embodiment can be further reduced by 0.35 dB in comparison with the first embodiment.

### Third Embodiment

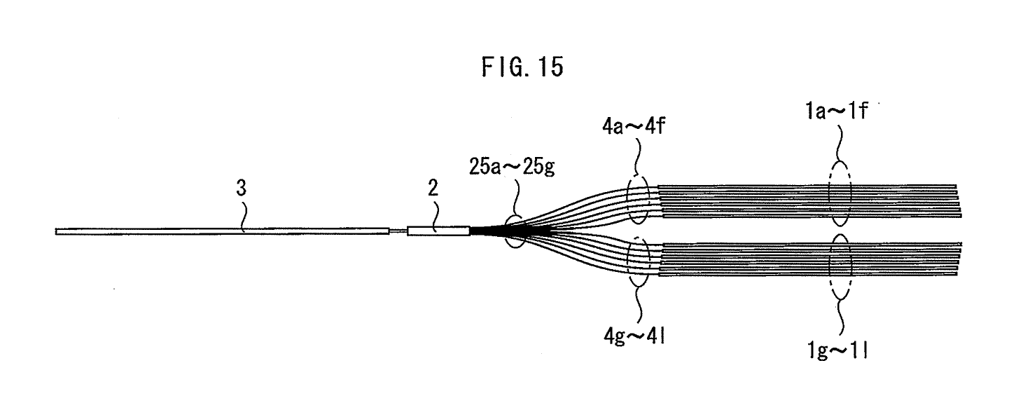

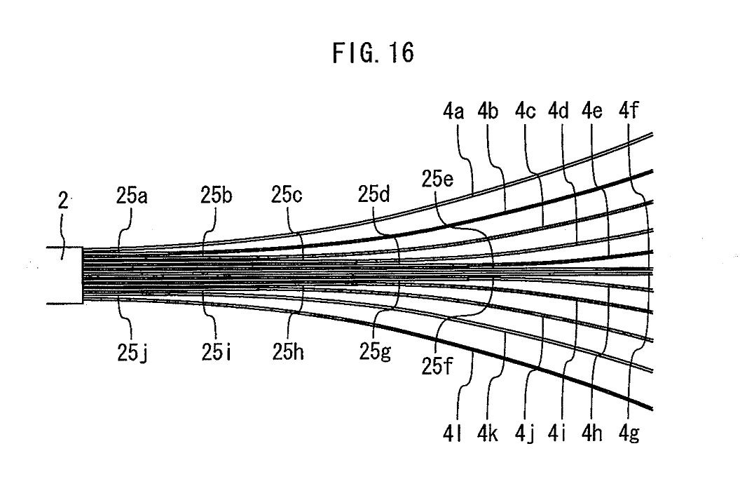

FIG. 15 is a top view of an optical semiconductor device according to a third embodiment of the present invention. FIG. 16 is an enlarged top view of a portion of the device shown in FIG. 15. Straight waveguides 25a to 25j are inserted between the plurality of bent waveguides 4b to 4k having the same radius of curvature and the MMI coupler 2 so that the lengths of the waveguides between the plurality of semiconductor lasers 1a to 1l and the MMI coupler 2 are equal to each other.

In this way, variation in loss can be further reduced in comparison with the first embodiment. Therefore, the differences between the quantities of return light to the plurality of semiconductor lasers 1a to 1l can be further reduced to further reduce variation in line width of output lights when the plurality of semiconductor lasers 1a and 1l are respectively driven.

Variation in loss was calculated by setting Δx of the outermost bent waveguides 4a and 4l in which the loss is maximized to 760 μm, setting Δy of these waveguides to 150 μm and setting the radii of curvature of these waveguides to 1000 μm. As a result of the calculation, variation in loss in the present embodiment can be further reduced by 0.35 dB in comparison with the first embodiment.

In the first to third embodiments, the quantum well active layer is InGaAsP. However, the present invention is not limited to this. The quantum well active layer may alternatively be InAlGaAs, for example. The radius of curvature is not limited to 1000 μm. The radius of curvature may alternatively be 500 μm or 2000 μm, for example. The number of semiconductor lasers is not limited to 12. The number of semiconductor lasers may be 12 or more, for example. The structure of the bent waveguides 4a to 4l is not limited to the burying structure. The structure of the bent waveguides 4a to 4l may alternatively be a mesa structure.

Obviously many modifications and variations of the present invention are possible in the light of the above teachings. It is therefore to be understood that within the scope of the appended claims the invention may be practiced otherwise than as specifically described.

The entire disclosure of Japanese Patent Application No. 2012-182906, filed on Aug. 22, 2012, including specification, claims, drawings, and summary, on which the Convention priority of the present application is based, is incorporated herein by reference in its entirety.

1. An optical semiconductor device comprising:
a plurality of semiconductor lasers separated into two groups;
an optical coupler combining light output from the semiconductor lasers;
an optical amplifier amplifying light output from the optical coupler; and
a plurality of waveguides respectively connecting the semiconductor lasers to the optical coupler, wherein
the plurality of waveguides includes respective bent waveguides, and
the respective bent waveguides all have the same radius of curvature.

2. The optical semiconductor device according to claim 1, wherein each bent waveguide includes two circular arcs having same radius of curvature and different curvature centers.

3. The optical semiconductor device according to claim 1, wherein
the plurality of waveguides includes respective straight waveguides, and lengths of the respective waveguides of the plurality of waveguides are equal to each other.
